(19) United States
(12) Patent Application Publication
(10) Pub. No.: US 2022/0285784 A1
(43) Pub. Date: Sep. 8, 2022

(54) BATTERY ARRANGEMENT, MOTOR VEHICLE, AND METHOD FOR DISCHARGING GASES FROM A BATTERY

(71) Applicant: AUDI AG, Ingolstadt (DE)

(72) Inventors: Carsten LORENZ, Reichertshofen (DE); Thomas MILDE, Wuestenrot (DE); Martin SCHUESSLER, Koesching (DE); Thomas WITTENSCHLAEGER, Ingolstadt (DE)

(73) Assignee: AUDI AG, Ingolstadt (DE)

(21) Appl. No.: 17/679,333

(22) Filed: Feb. 24, 2022

(30) Foreign Application Priority Data
Mar. 2, 2021 (DE) 102021104940.7

(51) Int. Cl. H01M 50/342; B60K 1/04; B60K 13/04; H01M 50/358

(52) U.S. Cl. CPC H01M 50/3425; B60K 1/04; B60K 13/04; H01M 50/358; B60K 2001/0438; H01M 2220/20

(57) ABSTRACT

A battery arrangement for a motor vehicle, which has a battery having at least one battery cell which has at least one releasable degassing opening, and a degassing device which is fluidically coupled to the degassing opening of the at least one battery cell and is designed to lead gases escaping from the at least one releasable degassing opening of the battery cell and entering the degassing device out of the battery. The degassing device has at least one exhaust gas duct arranged outside the battery, which is fluidically coupled to the battery and which is designed in such a way that a gas flowing into the exhaust gas duct via the coupling point can be conducted to an outlet opening of the exhaust gas duct.

### FIELD

The invention relates to a battery arrangement for a motor vehicle, wherein the battery arrangement has a battery, in particular a high-voltage battery, having at least one battery cell which comprises at least one releasable degassing opening, and a degassing device which is fluidically coupled to the degassing opening of the at least one battery cell and is designed, in the case that gas escapes from the at least one releasable degassing opening of the battery cell and enters the degassing device, to guide the gas out of the battery. Furthermore, the invention also relates to a motor vehicle having such a battery arrangement and a method for discharging a gas escaping from at least one battery cell of a battery of a motor vehicle.

### BACKGROUND

Batteries, in particular high-voltage batteries, for electric or hybrid vehicles typically have multicellular individual battery cells, which can also be combined into modules under certain circumstances. If there is a defect in a battery cell, for example as a result of an accident of the motor vehicle, such a battery cell may run away thermally. Such a thermal runaway can quickly propagate across all battery cells. In the course of such a thermal runaway, there is an increasing development of gas within a battery cell. In order to prevent such a battery cell from exploding, the battery cells therefore typically have releasable openings, for example in the form of bursting membranes. Often, when the cells open, the harmful gas is distributed in an undirected manner in the battery system as part of a thermal propagation and then conducted out of the housing.

Degassing devices are also known from the prior art which enable a deliberate discharge, for example in the form of ducts, of such a gas from the battery. For example, DE 10 2019 200 156 A1 describes a battery system having a battery housing which comprises a base body and a cover. A battery module having at least one battery cell is arranged in the battery housing, as well as a degassing duct for degassing the at least one battery cell. This degassing duct is formed in part by a structural element which provides a lower shell of the degassing duct and which is arranged on the battery cover, so that a part of the battery cover simultaneously forms an upper side of the degassing duct. The degassing duct can be arranged extending over the degassing openings of multiple battery cells, in particular in a straight line, and can lead to the housing edge of the battery housing, where the gas ultimately escapes from the battery housing.

Furthermore, DE 10 2013 204 585 A1 describes a battery pack having an overpressure release device and a particle separator. The gas escaping from the battery cells is first fed to a gas chamber into which the gas escaping from the cells expands in order to cool down. The gas is then fed from the gas chamber to a particle separator in order to separate particles contained in the gas therein. The particle separator can be arranged outside of the battery housing. The resulting gas can also be conducted out of the battery pack and out of the vehicle via piping.

The main problem with the gas discharge is that when one or more battery cells thermally run away, glowing sparks are also entrained by the approximately 1,200° C. hot gas flow. These ignite the burning gas mixture outside the battery housing. Even if, according to the prior art, attempts are made to prevent as many particles and sparks as possible from escaping from the battery, for example through the above-mentioned particle separator, a certain residual risk cannot be ruled out. While the gas flow may be partially cooled by the above-mentioned expansion, the gas is nonetheless generally still hot enough when it exits the vehicle to induce a potential hazard.

### SUMMARY

The object of the present invention is therefore to provide a battery arrangement, a motor vehicle, and a method which enable gases to be discharged from the battery in the safest possible manner in the event of a thermal runaway of a battery cell.

A battery arrangement according to the invention for a motor vehicle has a battery having at least one battery cell, which comprises at least one releasable degassing opening, and a degassing device fluidically coupled to the degassing opening of the at least one battery cell. This is designed to guide the gas out of the battery in the case that gas escapes from the at least one releasable degassing opening of the battery cell and enters the degassing device. The degassing device has at least one exhaust gas duct arranged outside the battery, which is fluidically coupled to the battery via a coupling point of the battery arrangement and which is designed in such a way that a gas flowing into the exhaust gas duct via the coupling point can be conducted to an outlet opening of the exhaust gas duct, which, when the battery arrangement is arranged on the motor vehicle as intended, opens into a motor vehicle region which is at least different from a region of an underbody of the motor vehicle which is arranged directly below the battery.

The invention is based on the finding that high-voltage batteries are typically arranged in the floor region of a motor vehicle, in particular between the wheel axles or even beyond them in the longitudinal direction. Discharge positions previously used for gas discharge, in order to discharge the gas guided out of the battery from the vehicle, are often arranged in the direct vicinity of the battery and the passenger compartment. This has the disad-vantage that a gas mixture that ignites when it escapes can pose a possible hazard to passengers of the motor vehicle. This can also make it more difficult for rescue workers to rescue passengers.

The invention now uses this finding in that the exhaust gas duct exits from the vehicle at a point which is different from a point which is particularly critical for the battery and for passengers, namely at least is different from a region of an underbody of the motor vehicle which is arranged directly below the battery. If hot and potentially flammable gases and smoke were to escape there, on the one hand, the battery and thus also the passenger compartment would heat up from below, and in addition the possibly burning gases would also escape laterally via the side sill and door region, and could also prevent or impede the exit of passengers from the vehicle. The outlet opening, from which escaping gas not only leaves the exhaust gas duct but escapes from the entire vehicle, can advantageously also be positioned, for example, in such a way that it differs from a side door region or side sill region. This enables the rescue or exit of the passengers in the easiest and safest manner possible. The outlet opening can also be positioned in such a way that it opens into a motor vehicle region which is different from an entire underbody of the motor vehicle located between two wheel axles of the motor vehicle. It may also be positioned such that its position differs from a wheel well of the motor vehicle and is located farther away from the battery than the wheel well. The exhaust gas duct according to the invention now provides numerous possibilities for discharging the escaping gas significantly both farther away from the battery and farther away from the passenger region, as a result of which safety can be increased in many respects. Even if the escaping gas mixture ignites, it can no longer represent a hazard due to its great distance from the passenger compartment. When rescuing passengers, rescue personnel are also not negatively affected by the escaping gas mixture, neither by the possible formation of flames nor by potentially harmful substances that may be contained in the gas. In addition, heat feedback into the battery can be avoided or at least reduced due to the very remote outlet point. A thermal propagation propagating in the battery can be slowed down as a result. However, another particularly great advantage is moreover that the gas has to travel a significantly longer distance to the outlet point, whereby further cooling of the gas can be achieved. This can additionally reduce the risk of ignition. The gas mixture can thus advantageously be guided by means of an exhaust system, which can be comparable to that of an internal combustion engine, for example, from the battery to a vehicle region where there is no hazard or only a low risk for the passengers. In this way, targeted exhaust gas guiding can advantageously be provided, so that harmful gases no longer pose a direct or indirect hazard to the passengers.

The battery preferably represents a high-voltage battery for a motor vehicle, in particular for an electric or hybrid vehicle. In this case, the battery can have numerous individual battery cells, for example also in the form of battery modules each having a plurality of battery cells. The battery cells can be formed, for example, as lithium-ion cells. Furthermore, the battery cells can represent round cells, prismatic cells, and/or pouch cells.

An at least releasable degassing opening of the battery cells can be understood to mean either a degassing opening that is permanently open, in particular in the cell casing or the cell housing, or, as is preferred, a degassing opening that is normally closed and is only released under a certain condition, for example, when there is a corresponding overpressure within the battery cell or when a certain limiting temperature is exceeded. The releasable degassing opening is preferably designed as a bursting membrane, but can also be provided by a pressure relief valve or the like.

Furthermore, the degassing device can have a degassing duct that extends inside the battery. This degassing duct can extend, for example, over the respective degassing openings of the battery cells. Duct openings assigned to the degassing openings can also be arranged in the degassing duct, through which the gas escaping from the battery cells can enter the degassing duct. Such a degassing duct can be arranged, for example, between the battery cells and a housing cover of a battery housing of the battery. Preferably, such a degassing duct is elongated in shape and not in the form of an extended gas receptacle chamber. This has the great advantage that a directed gas flow can be achieved without turbulence in this way. The probability of undesired particle deposits at narrow points due to premature gas cooling and expansion can be avoided in this way. In addition, the gas discharge may thereby be accelerated. Because the invention makes it possible in any case to let the gas escape from the vehicle at a safe outlet point, even ignition of the gas mixture when it escapes would no longer pose a major hazard potential for the passengers. Furthermore, the degassing duct, that is to say the part of the degassing device extending inside the battery, can also be guided through frame parts of the battery housing. The battery therefore preferably has a battery housing which can, for example, comprise a frame which is provided at least in some regions by a hollow profile. Such hollow profiles or the hollow chambers contained therein can also be used for gas discharge. This is particularly space-efficient and allows gas to be discharged at almost any desired outlet point on the battery. Such an outlet point is also referred to here as a coupling point, at which the exhaust gas duct can be connected to the battery.

Furthermore, the gas-guiding parts of the degassing device, i.e., for example, the degassing duct extending in the battery and/or the exhaust gas duct extending outside, are made of a temperature-resistant material, preferably a metal or an alloy, particularly preferably steel. The exhaust gas duct can be designed, for example, as a pipe or metal hose or the like.

The exhaust gas duct is therefore made sufficiently long to guide the gas guided through it to an outlet point, namely the outlet opening, which is preferably more remote from the battery than, for example, a wheel well, in particular than each of the wheel wells of the motor vehicle in which the battery arrangement according to the invention or one of its designs is used. The battery of the battery arrangement can in particular be designed as a high-voltage battery, which is provided or designed to be arranged in an underbody region of the motor vehicle.

Furthermore, the invention also relates to a motor vehicle having a battery arrangement according to the invention or one of its designs. The above-described advantages therefore apply in the same way to the motor vehicle according to the invention. The motor vehicle according to the invention is preferably designed as an automobile, in particular as a passenger car or truck, or as a passenger bus or motorcycle.

In a very advantageous embodiment of the invention, the outlet opening is arranged in a rear region of the motor vehicle. In other words, the exhaust gas duct can be guided through the rear part of the motor vehicle to a rear end of the motor vehicle. At this point, the outlet opening is advantageously at a maximum distance from both the battery and the passengers. Furthermore, this advantageous embodiment is based on the knowledge that the driver's seat of a motor vehicle and thus the passenger region at the front of the motor vehicle is always occupied, while this is not always the case for the front passenger region. From a statistical point of view, the discharge of the gases via the rear region of the motor vehicle is therefore significantly safer for the passengers than, for example, via the front region of the motor vehicle, since this maximizes the statistical average distance from the passengers. From a statistical point of view, accidents having front impact also occur more often than accidents having rear impact. The gas discharge in the rear region thus increases the probability that the exhaust gas duct will remain largely intact in the event of an accident and unimpaired gas discharge will be provided. For example, the outlet opening can be arranged in the baggage compartment region or where the conven-tional exhaust pipe of the motor vehicle is also provided. If ignited gas escapes at this point, it also does not represent any negative affect for rescue workers at this position. The safety of the passengers can thus be increased overall.

Nevertheless, it is also conceivable that the outlet opening is arranged in a front region of the motor vehicle and/or in a roof region of the motor vehicle. The outlet opening is also very remote from the passenger region at these points. In particular, the same applies to the front region of the motor vehicle as described for the rear region of the motor vehicle. The distance to the passenger compartment is also very large here, as is the distance to the battery itself. An embodiment in the roof region of the motor vehicle can also be re-garded as relatively nonhazardous, since the escaping hot gas would immediately rise upwards and would therefore not impair the passenger compartment below in any way.

In one particularly advantageous embodiment of the invention, the motor vehicle has a body having a support structure which has a support structure component designed as a hollow profile, wherein at least part of the exhaust gas duct is provided by at least part of the support structure component. In other words, support structures on the body can be used as exhaust gas ducts for discharging the gas from the battery. This in turn is based on the knowledge that the vehicle body often uses support structures which are designed as hollow profiles and thus already provide unused ducts. Like side members, these also extend through the entire motor vehicle, so that both a desired entry location and also an outlet location for providing the outlet opening can be selected in a simple manner. For example, the coupling point on the battery can easily be connected to such a hollow profile of the motor vehicle body structure and the gas discharged from the battery can thus be discharged via this body structure to the desired outlet opening, which is preferably arranged in the rear region. Such a support structure of the body is typically very robust in any case and in particular is made of metal, in particular steel, and is therefore made extremely temperature-resistant, so that it is also outstandingly suitable for discharging such hot gases. This means that weight, costs, and installation space can be saved.

According to a further very advantageous embodiment of the invention, a particle trap for separating particles from the gas flowing through the part of the support structure component is arranged in an interior space of the at least one part of the support structure component. For example, chambers and cavities of these support structure components can additionally be used to integrate spark traps or particle traps therein. Such particle traps can be provided, for example, in the form of a filter, such as a type of wadding made of steel wool, in which particles of the gas flow can easily become trapped and thus separate. Such a particle trap can also be provided by a labyrinthine structure within the support structure component. Because a gas has to flow through such a labyrinth, similar to a siphon, particles are increasingly also separated here. In addition, such a gas deflection results in slowing down and thus cooling of the gas flow. The natural deflection due to the geometric design of the support structure component itself also results in slowing down of the gas and accordingly in cooling and increased particle separation. The gas cooling and particle separation can be forced in particular by a gas path that is as long as possible. The safety may be further increased in this way. The probability that sparks will ultimately escape from the outlet opening can be reduced to a minimum as a result. Accordingly, the discharged gas is very unlikely to ignite when escaping from the outlet opening

In a further advantageous embodiment of the invention, the support structure component represents a tubular structure of an axle support and/or a rear axle subframe of the vehicle body. Such an axle support or rear axle subframe often has a tubular structure whose diameter is sufficient to be able to safely discharge the gas flow. A particularly great advantage of using this tubular structure in particular is that the axle support or rear axle subframe often begins exactly where the battery ends, so that the battery can be connected to such a support structure component in a particularly simple manner. In addition, the axle support or rear axle subframe leads through the rear part to the rear end, so that the above-mentioned outlet opening can advantageously be provided in the rear region of the motor vehicle. As a result, no separate exhaust gas duct has to be provided.

In a further very advantageous embodiment of the invention, the support structure component represents a side member and/or side sill of the motor vehicle. This has the great advantage that side members or side sills typically also extend in the vehicle longitudinal direction and are therefore particularly advantageously suitable for transporting the gas to the rear and/or at least to the rear axle support or the rear axle subframe. For example, the gas can also be discharged from the battery at the front side or in a central region thereof and introduced into the side member and/or side sill and guided out of the motor vehicle via these in the front or rear region. This also advantageously allows a very long route to be provided, which the gas first has to pass through to the outlet point, which in turn allows increasing cooling and particle separation to be achieved.

In order to discharge the gas in the roof region of the motor vehicle, for example, parts of the A pillar and/or B pillar and/or C pillar of the motor vehicle can also be used analo-gously, if they are also designed as hollow profiles. Cavities in body structures can thus be used particularly advantageously overall, such as side members and sills or tubular structures in rear axle subframes, in order to channel the gas and discharge it from the motor vehicle at the desired point very remote from the passenger compartment.

In a further advantageous embodiment of the invention, at least part of the exhaust gas duct is provided by at least part of an underbody cladding or the drag reduction cladding of the motor vehicle and/or tension struts and/or metal sheets in the region of an underbody of the motor vehicle. The drag reduction cladding represents the underbody cladding that delimits the vehicle downwards in order to provide the best possible aerodynamic drag coefficient of the motor vehicle. Tension struts and/or such cladding or metal sheets in the underbody region advantageously provide numerous gaps, in particular also flat gaps, which can be used to guide the gas over very long distances in the underbody region and automatically as far as possible away from it, for example in the rear region. Since these already existing structures are metallic, they automatically provide high temperature resistance in any case, so that they can be used as part of the exhaust gas duct. In a further advantageous embodiment of the invention, the exhaust gas duct has a first section, the interior of which is arranged through a space between a cooling base of the battery for cooling the at least one battery cell and an underride guard of the motor vehicle, wherein the underride guard is arranged below the cooling base and the cooling base is arranged below the at least one battery cell. Existing structures for gas discharge can also be used in this way. In this case, the space between the cooling base and the underride guard is used as the exhaust gas duct. This has the great advantage that the cooling base provides an additional barrier upwards toward the battery and the passenger compartment, since the cooling base is usually filled with a coolant, in particular water. The underride guard is also designed to be correspondingly robust and is typically made of metal, so that it is also suitable as a duct wall for the exhaust gas duct. This first section of the exhaust gas duct can then be correspondingly coupled to a second section of the exhaust gas duct, which is preferably provided by one of the above-mentioned support structure components. Thus, overall, a particularly efficient, space-saving, and safe gas discharge can be provided.

Furthermore, the invention also relates to a method for discharging a gas escaping from at least one battery cell of a battery of a motor vehicle by means of a degassing device which is fluidically coupled to at least one releasable degassing opening of the battery cell, wherein if gas escapes from the at least one releasable degassing opening of the battery cell, the gas at least partially enters the degassing device and is guided out of the battery by means of the degassing device. The degassing device has at least one exhaust gas duct arranged outside the battery, which is fluidically coupled to the battery via a coupling point of the battery arrangement and which conducts the gas flowing into the exhaust gas duct via the coupling point to an outlet opening of the exhaust gas duct, which opens into a motor vehicle region which is at least different from a region of an underbody of the motor vehicle which is arranged directly below the battery.

The advantages mentioned for the battery arrangement according to the invention and the motor vehicle according to the invention and their designs thus apply similarly to the method according to the invention.

The invention also includes refinements of the method according to the invention, which have features as already described in the context of the refinements of the battery arrangement according to the invention and the motor vehicle according to the invention. For this reason, the corresponding refinements of the method according to the invention are not described again here.

In a further advantageous refinement of the method according to the invention, it can be provided that the gas conducted via the exhaust gas duct is filtered. Such filtering can be provided, for example, using the particle trap already described above.

The invention also comprises combinations of the features of the described embodiments. The invention also includes implementations that each have a combination of the features of several of the described embodiments, provided that the embodiments were not described as mutually exclusive.

### BRIEF DESCRIPTION OF THE FIGURES

Exemplary embodiments of the invention are described hereinafter. In the figures:

FIG. 1 shows a schematic and perspective illustration of a battery arrangement according to one exemplary embodiment of the invention;

FIG. 2 shows a schematic illustration of a motor vehicle having a part of a battery arrangement according to one exemplary embodiment of the invention;

FIG. 3 shows a schematic illustration of a part of the motor vehicle having a part of the battery arrangement according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those illustrated. Furthermore, the described embodiments can also be supplemented by further ones of the above-described features of the invention.

In the figures, the same reference signs designate elements that have the same function.

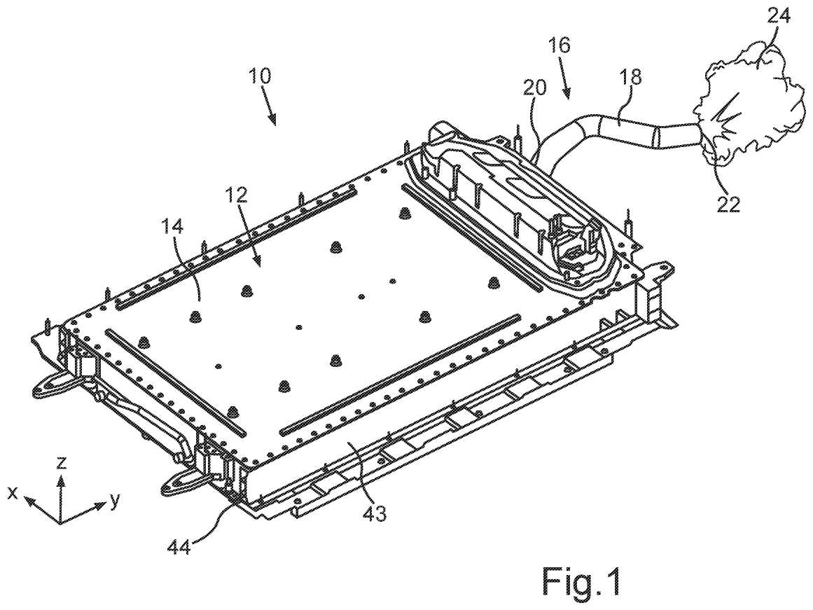

FIG. 1 shows a schematic illustration of a battery arrangement 10 according to one exemplary embodiment of the invention. The battery arrangement 10 has a battery 12 which comprises a battery housing 14 in which at least one battery cell is arranged. In the present example, the battery 12 is designed as a high-voltage battery 12 and includes numerous battery cells that cannot be seen here because of the housing 14.

For example, the battery 12 can comprise between 200 and 400 battery cells. Furthermore, the battery arrangement 10 has a degassing device 16, of which only a part which is arranged outside of the battery 12 and which represents an exhaust gas duct 18 can be seen in the present case.

If there is a defect of battery cells within the battery 12, the battery cells can thermally run away. As a result, gases escape from the battery cells, which can be discharged through corresponding releasable degassing openings provided in the battery cells. The gases escaping from the cells then enter at least one degassing duct provided in the battery 12 as part of the degassing device 16. This degassing duct is made of a temperature-resistant material, for example steel, and discharges the gas from the battery 12, in particular up to a coupling point 20 at which the exhaust duct 18 is connected to the battery 12, in order to pass on the escaping gas, specifically up to an outlet opening 22 of the exhaust gas duct 18.

The gas is typically discharged from the battery in such a way that such an outlet point opens very close to the battery itself or a passenger compartment of the motor vehicle in which the battery is installed. Since the discharged hot gases can also contain sparks that can ignite the escaping gas mixture, as is also illustrated in FIG. 1, for example, where the ignited gas mixture is identified by 24, this can be accompanied by a high hazard potential for the passengers and for possible rescue workers when rescuing the passengers.

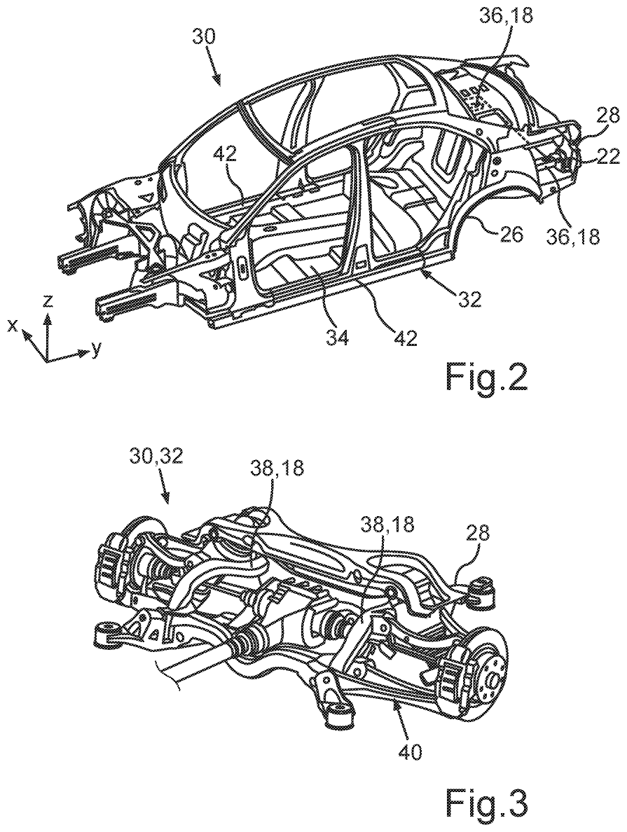

In contrast, the present battery arrangement 10 is now advantageously designed such that the exhaust gas duct 18 discharges the gas to a point that is very remote from the passenger compartment and from the battery 12 itself, and which is in particular significantly more remote from the battery and the passenger compartment than, for example the wheel wells 26 of the motor vehicle (cf. FIG. 2). The outlet opening 22 is preferably arranged in a rear region 28 of the motor vehicle 30, as will be explained in more detail below.

FIG. 2 shows a schematic and perspective illustration of a motor vehicle 30 having a body structure 32. Such a body structure 32 fundamentally has many support structure components which are designed as hollow profiles or have hollow chambers or are designed having a hollow interior, and which moreover can extend over parts, in particular large parts, of the motor vehicle 10, above all in the illustrated Y direction. For the sake of clarity, the battery 12 is not shown in FIG. 2, but it should be considered to be comprised by the motor vehicle 30. In particular, this battery 12 is arranged in an underbody region 34 of the motor vehicle and can extend in the Y direction, for example, over the complete region between a front wheel and a rear wheel of the motor vehicle 30.

Since such a body structure 32 thus has many structural elements or structural components that are hollow on the inside and are moreover made of temperature-resistant material, in particular steel and/or aluminum, these structural components can advantageously be used to function as an exhaust gas duct 18, at least in certain regions. In other words, the exhaust gas duct 18 described for FIG. 1 does not necessarily have to be provided as an independent component, but can be provided at least in part by at least one part of such a support structure component of the body structure 32. For example, the support structure component 36 shown in FIG. 2, which in particular represents a part of a side member of the motor vehicle 30, is particularly suitable. This support structure component 36 ends in the rear region 28 and is therefore particularly suitable for guiding the gas from the battery 12 to the rear region 28 and allowing it to escape from the vehicle 30 there. This support structure component 36 thus ends at the rear at a particularly harmless point for passengers.

Additionally or alternatively, a tubular structure 38 (cf. FIG. 3) of an axle support 40 or a rear axle subframe 40 can thus also be used at least partially on the exhaust gas duct 18. This is illustrated schematically in FIG. 3.

FIG. 3 shows part of a motor vehicle 30, in particular in the rear region 28, having the tubular structures 38 of the axle support 40 of the motor vehicle body 32, which can also be used as exhaust gas ducts 18.

Furthermore, cavities in such body structures 32 or support structure components 36, 38 can be used to also integrate spark traps or particle traps in these cavities or chambers. Other body structures 32, for example side members or sills 42 (see FIG. 2) can also be used as exhaust gas ducts 18 in order to channel the discharged gas. In addition, battery profiles or hollow profiles of the frame 43 of the battery housing 14, which is also shown in FIG. 1, can also be used for the gas guiding, or also regions between an underride guard of the motor vehicle 30 and a cooling base of the battery 12, which is identified by 44 in FIG. 1.

Overall, the examples show how the invention can provide an exhaust system for discharging gases from a high-voltage battery, which enables targeted exhaust gas removal so that harmful gases do not pose a direct or indirect hazard to the passengers of the motor vehicle. By means of such an exhaust system, the escaping gas mixture can advantageously be guided from the battery to a region of the vehicle where there is no hazard or only a minor risk for the passengers. This preferably represents the vehicle rear region.

1. A battery arrangement for a motor vehicle, comprising: a battery having at least one battery cell which has at least one releasable degassing opening, and a degassing device which is fluidically coupled to the degassing opening of the at least one battery cell and is designed, in the case that gas escapes from the at least one releasable degassing opening of the battery cell and enters the degassing device, to lead the gas out of the battery, wherein the degassing device has at least one exhaust gas duct arranged outside the battery, which is fluidically coupled to the battery via a coupling point of the battery arrangement and which is designed in such a way that a gas flowing into the exhaust gas duct via the coupling point can be conducted to an outlet opening of the exhaust gas duct, which, when the battery arrangement is arranged on the motor vehicle as intended, opens into a motor vehicle region which is at least different from a region of an underbody of the motor vehicle which is arranged directly below the battery.

2. A motor vehicle having a battery arrangement, the battery arrangement comprising: a battery having at least one battery cell which has at least one releasable degassing opening, and a degassing device which is fluidically coupled to the degassing opening of the at least one battery cell and is designed, in the case that gas escapes from the at least one releasable degassing opening of the battery cell and enters the degassing device, to lead the gas out of the battery, wherein the degassing device has at least one exhaust gas duct arranged outside the battery, which is fluidically coupled to the battery via a coupling point of the battery arrangement and which is designed in such a way that a gas flowing into the exhaust gas duct via the coupling point can be conducted to an outlet opening of the exhaust gas duct, which, when the battery arrangement is arranged on the motor vehicle as intended, opens into a motor vehicle region which is at least different from a region of an underbody of the motor vehicle which is arranged directly below the battery.

3. The motor vehicle as claimed in claim 2, wherein the outlet opening is arranged in a rear region of the motor vehicle.

4. The motor vehicle as claimed in claim 2, wherein the outlet opening is arranged in a front region of the motor vehicle and/or in a roof region of the motor vehicle.

5. The motor vehicle as claimed in claim 2, wherein the motor vehicle has a body having a support structure, which has a support structure component designed as a hollow profile, wherein at least part of the exhaust gas duct is provided by at least one part of the support structure component.

6. The motor vehicle as claimed in claim 5, wherein a particle trap for separating particles from the gas flowing through the part of the support structure component is arranged in an interior space of at least one part of the support structure component.

7. The motor vehicle as claimed in claim 2, wherein the support structure component represents a tubular structure of an axle support and/or rear axle subframe of the body and/or a side member and/or side sill.

8. The motor vehicle as claimed in claim 2, wherein at least part of the exhaust gas duct is provided by at least part of an underbody cladding of the motor vehicle and/or tension struts and/or metal sheets in the region of an underbody of the motor vehicle.

9. The motor vehicle as claimed in claim 2, wherein the exhaust gas duct has a first section, the interior of which is arranged through a space between a cooling base of the battery for cooling the at least one battery cell and an underride guard of the motor vehicle, wherein the underride protection is arranged below the cooling base in relation to a motor vehicle vertical direction and the cooling base is arranged below the at least one battery cell.

10. A method for discharging a gas escaping from at least one battery cell of a battery of a motor vehicle by a degassing device which is fluidically coupled to at least one releasable degassing opening of the battery cell, wherein if gas escapes from the at least one releasable degassing opening of the battery cell, the gas at least partially enters the degassing device and is guided out of the battery by means of the degassing device, wherein the degassing device has at least one exhaust gas duct arranged outside the battery, which is fluidically coupled to the battery via a coupling point of the battery and which conducts the gas flowing into the exhaust gas duct via the coupling point to an outlet opening of the exhaust gas duct, which opens into a motor vehicle region which is at least different from a region of an underbody of the motor vehicle which is arranged directly below the battery.

11. The motor vehicle as claimed in claim 3, wherein the outlet opening is arranged in a front region of the motor vehicle and/or in a roof region of the motor vehicle.

12. The motor vehicle as claimed in claim 3, wherein the motor vehicle has a body having a support structure, which has a support structure component designed as a hollow profile, wherein at least part of the exhaust gas duct is provided by at least one part of the support structure component.

13. The motor vehicle as claimed in claim 4, wherein the motor vehicle has a body having a support structure, which has a support structure component designed as a hollow profile, wherein at least part of the exhaust gas duct is provided by at least one part of the support structure component.

14. The motor vehicle as claimed in claim 3, wherein the support structure component represents a tubular structure of an axle support and/or rear axle subframe of the body and/or a side member and/or side sill.

15. The motor vehicle as claimed in claim 4, wherein the support structure component represents a tubular structure of an axle support and/or rear axle subframe of the body and/or a side member and/or side sill.

16. The motor vehicle as claimed in claim 5, wherein the support structure component represents a tubular structure of an axle support and/or rear axle subframe of the body and/or a side member and/or side sill.

17. The motor vehicle as claimed in claim 6, wherein the support structure component represents a tubular structure of an axle support and/or rear axle subframe of the body and/or a side member and/or side sill.

18. The motor vehicle as claimed in claim 3, wherein at least part of the exhaust gas duct is provided by at least part of an underbody cladding of the motor vehicle and/or tension struts and/or metal sheets in the region of an underbody of the motor vehicle.

19. The motor vehicle as claimed in claim 4, wherein at least part of the exhaust gas duct is provided by at least part of an underbody cladding of the motor vehicle and/or tension struts and/or metal sheets in the region of an underbody of the motor vehicle.

20. The motor vehicle as claimed in claim 5, wherein at least part of the exhaust gas duct is provided by at least part of an underbody cladding of the motor vehicle and/or tension struts and/or metal sheets in the region of an underbody of the motor vehicle.
